(19) United States
(12) Patent Application Publication
(10) Pub. No.: US 2026/0043885 A1
(43) Pub. Date: Feb. 12, 2026

(54) RADIOTAG DEVICES WITH SEAMLESS MULTI-PLATFORM SUPPORT

(71) Applicant: PB Inc., Issaquah, WA (US)

(72) Inventors: Daniel J. Daoura, Renton, WA (US); Pawel Kazimierowicz, Krakow (PL)

(73) Assignee: PB Inc., Issaquah, WA (US)

(21) Appl. No.: 18/798,663

(22) Filed: Aug. 8, 2024

(51) Int. Cl. G01S 1/04; H04W 4/80; H04W 12/50

(52) U.S. Cl. CPC G01S 1/042; H04W 12/50; H04W 4/80

(57) ABSTRACT

In some embodiments, a computer-implemented method of operating a radiotag with a communication platform of two or more supported communication platforms is provided. An application service of the radiotag instantiates a plurality of service stack threads. Each service stack thread determines whether bonding information for a communication platform associated with the service stack thread is stored in a service configuration data storage of the radiotag.

For each service stack thread, in response to determining that the bonding information for the communication platform associated with the service stack thread is not stored in the service configuration data storage, the service stack thread enters a waiting state; and in response to determining that the bonding information for the communication platform associated with the service stack thread is stored in the service configuration data storage, the service stack thread generates one or more beacons in a format for the associated communication platform.

### TECHNICAL FIELD

This disclosure relates generally to wireless communication, and in particular but not exclusively, relates to portable devices that provide wireless beacons.

### BACKGROUND

Wireless asset tracking is an increasingly used technology that enables end users to locate lost items over wide areas. Typically, a tracking device, sometimes referred to as a “radiotag,” is attached to an asset to be tracked. The radiotag is configured to broadcast signals, or “beacons,” that allow the radiotag to be identified. Once the beacons are received, the location of the radiotag can be reported, and the reported location can be used to locate the asset. Multiple competing, mutually incompatible platforms have been created to support wireless asset tracking. What is desired are techniques that allow a single radiotag to be configurable to operate with more than one platform.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a computer-implemented method of operating a radiotag with a communication platform of two or more supported communication platforms is provided. An application service of the radiotag instantiates a plurality of service stack threads that includes a service stack thread for each of the two or more supported communication platforms. Each service stack thread determines whether bonding information for the communication platform associated with the service stack thread is stored in a service configuration data storage of the radiotag. For each service stack thread, in response to determining that the bonding information for the communication platform associated with the service stack thread is not stored in the service configuration data storage, the service stack thread enters a waiting state; and in response to determining that the bonding information for the communication platform associated with the service stack thread is stored in the service configuration data storage, the service stack thread generates one or more beacons in a format for the communication platform associated with the service stack thread.

In some embodiments, a radiotag comprising a wireless communication interface, at least one processor, and a non-transitory computer-readable medium is provided. The non-transitory computer-readable medium includes a primary firmware area and a secondary firmware area. The primary firmware area has stored therein computer-executable instructions comprising: two or more pruned service stacks; a common interface; a middleware service that connects the common interface to the two or more pruned service stacks; and an application service. Each pruned service stack of the two or more pruned service stacks includes a subset of instructions of a service stack for communicating with a corresponding communication platform. The application service accesses functionality of the two or more pruned service stacks via the common interface and the middleware service.

In some embodiments, a non-transitory computer-readable medium having computer-executable instructions stored thereon is provided. The instructions, in response to execution by one or more processors of a radiotag, cause the radiotag to perform actions for operating the radiotag with a communication platform of two or more supported communication platforms, the actions comprising: instantiating, by an application service of the radiotag, a plurality of service stack threads that includes a service stack thread for each of the two or more supported communication platforms; determining, by each service stack thread, whether bonding information for the communication platform associated with the service stack thread is stored in a service configuration data storage of the radiotag; and for each service stack thread: in response to determining that the bonding information for the communication platform associated with the service stack thread is not stored in the service configuration data storage, entering, by the service stack thread, a waiting state; and in response to determining that the bonding information for the communication platform associated with the service stack thread is stored in the service configuration data storage: generating, by the service stack thread, one or more beacons in a format for the communication platform associated with the service stack thread.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a perspective view of a non-limiting example embodiment of a radiotag according to various aspects of the present disclosure.

FIG. 2 is a block diagram that illustrates a non-limiting example of internal components of the radiotag according to various aspects of the present disclosure.

FIG. 3 is a schematic illustration of a basic system in which a radiotag operates, according to various aspects of the present disclosure.

FIG. 4 is a schematic illustration of a system in which a single radiotag supports communication with one of a plurality of communication platforms, according to various aspects of the present disclosure.

FIG. 5 is a schematic illustration of a computer-readable medium of a radiotag that illustrates example technical problems in implementing a radiotag that is compatible with more than one communication platform.

FIG. 6 is a schematic illustration of a computer-readable medium of a radiotag that shows a non-limiting example of techniques for overcoming technical problems in implementing a radiotag that is compatible with more than one communication platform, according to various aspects of the present disclosure.

FIG. 7A-FIG. 7C are a flowchart that illustrates a method of operating a radiotag with a communication platform of two or more supported communication platforms according to various aspects of the present disclosure.

FIG. 8 and FIG. 9 are sequence diagrams that illustrate timing aspects of non-limiting examples of the method of operating a radiotag with a communication platform of two or more supported communication platforms as illustrated in FIG. 7A-FIG. 7C, according to various aspects of the present disclosure.

### DETAILED DESCRIPTION

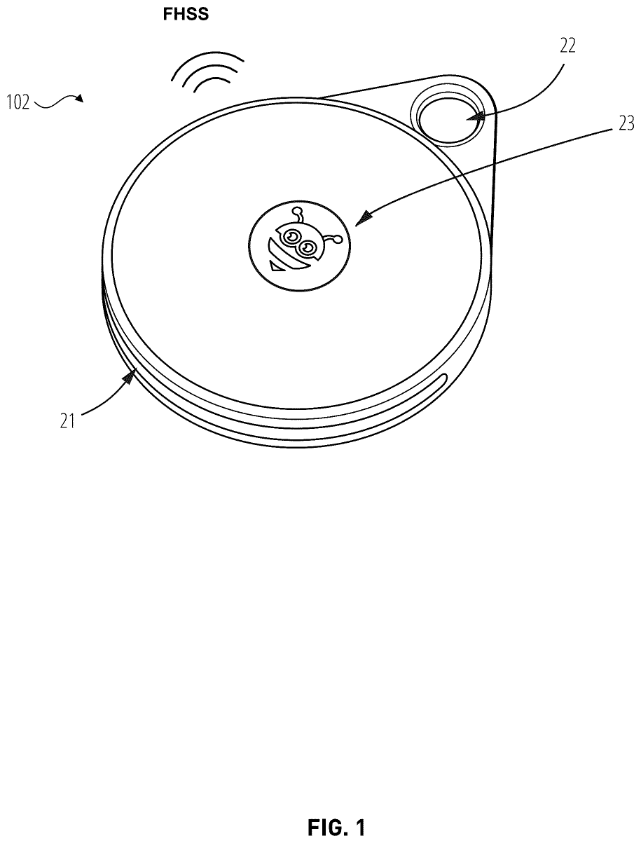

FIG. 1 is a perspective view of a non-limiting example embodiment of a radiotag 102 according to various aspects of the present disclosure. As shown, the radiotag 102 has a discoid form factor and annulet 22 for attaching the radiotag 102 to an object for which tracking services are desired.

The radiotag 102 includes an activation button 23 that is pressable and is located at the center of the illustrated device. In other embodiments, an activation button 23 may be positioned on the edge of the body, within a recess, and/or at any other suitable location. The radiotag 102 also includes an LED 21, which occupies about half of the edge so that a visual alert signal is easily spotted.

The radiotag 102 also includes additional internal components to provide various functionality. For example, the radiotag 102 may include a piezo speaker with adjustable volume for presenting chimes, alerts, and/or other audio presentations. As another example, the radiotag 102 typically includes a frequency-hopping spread spectrum (FHSS) or other type of radio transceiver under control of a SoC having a microprocessor and a battery power supply in order to announce the presence of the radiotag 102 to other devices, to bond the radiotag 102 to a communication platform, to receive over-the-air firmware updates, and/or for performing various other communication tasks. In some embodiments, a socket and recharging circuit (and/or an inductive charging circuit) may be present in order to recharge the battery. In other embodiments, the radiotag 102 may be powered by a removable, disposable battery.

The discoid form factor illustrated in FIG. 1 is a non-limiting example embodiment only, and in other embodiments, different form factors may be used. As one non-limiting example, a magnetic body may be used instead of an annulet 22 as a means for attachment of the radiotag 102 to an item for which tracking services are desired. As another non-limiting example, a radiotag of any form factor can be simply dropped in a pocket of a garment or backpack, for example, to provide tracking services for the garment or backpack. Another non-limiting example of a form factor for a radiotag is a card form factor, making the radiotag convenient to be carried in a wallet.

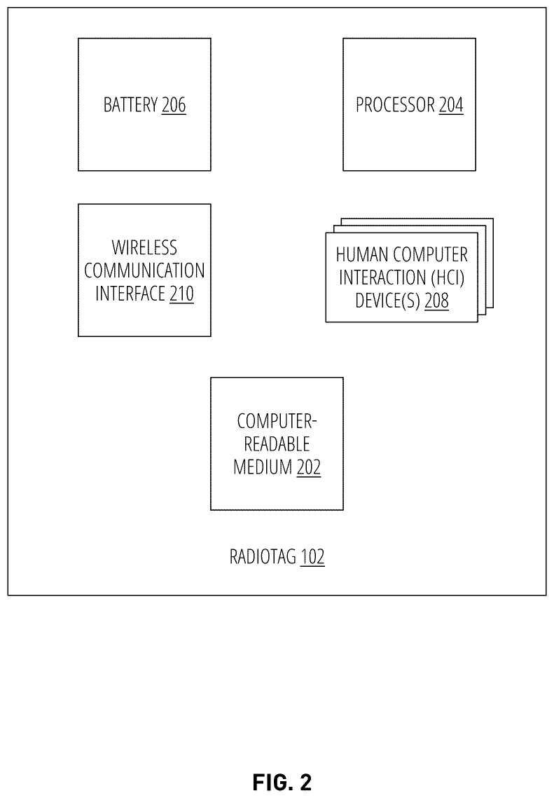

FIG. 2 is a block diagram that illustrates a non-limiting example of internal components of the radiotag according to various aspects of the present disclosure. As shown, the radiotag 102 includes a battery 206, a processor 204, a wireless communication interface 210, one or more HCl devices 208, and a computer-readable medium 202.

In some embodiments, the battery 206 is configured to provide power to the other components of the radiotag 102, thereby allowing the radiotag 102 to operate without being coupled to an external power source. In some embodiments, the battery 206 may be a rechargeable battery, and the radiotag 102 may include circuitry for allowing the battery 206 to be recharged, including but not limited to one or more of a socket for a charging cord or an inductive charging circuit. In some embodiments, the battery 206 may be a removable, disposable battery, and a housing of the radiotag 102 may provide access to the battery 206 to allow it to be replaced once it is depleted.

In some embodiments, the wireless communication interface 210 includes circuitry for providing frequency-hopping spread spectrum (FHSS) communication to and from the radiotag 102, and may include one or more antennas and/or one or more software stacks to enable the communication. In some embodiments, the wireless communication interface 210 may implement communication via a Bluetooth standard, including but not limited to a Bluetooth Low Energy (BLE) standard. In some embodiments, the wireless communication interface 210 may implement other wireless standards instead of or in addition to Bluetooth and/or BLE.

In some embodiments, the HCl devices 208 may include one or more buttons for receiving input from an end user, one or more speakers for generating audio signals, and/or one or more LEDs for generating visual signals to an end user, as illustrated in FIG. 1. In some embodiments, the HCl devices 208 may include other devices instead of or in addition to these illustrated devices, including but not limited to a haptic feedback device for generating haptic signals and/or one or more motion sensor devices for generating motion data.

In some embodiments, the processor 204 may be any suitable type of processor 204 that may execute computer-executable instructions stored within the computer-readable medium 202, receive signals from the other components of the radiotag 102, and transmit signals to control the other components of the radiotag 102. In some embodiments, the computer-readable medium 202 may include more than one type of computer-readable medium. For example, the computer-readable medium 202 may include a volatile computer-readable medium (e.g., RAM) for storing information generated during operation of the radiotag 102, a run-time editable non-volatile computer-readable medium (e.g., flash memory) for storing configuration information that can be changed at runtime, and/or a non-volatile computer-readable medium that is not editable at run-time (e.g., an EEPROM) for storing firmware.

Though illustrated as separate components, in some embodiments, two or more of these illustrated components may be provided as an integrated component such as a System on Chip (SoC) device. One non-limiting example of a SoC device that provides several of the components is the nRF52833 SoC provided by Nordic Semiconductor, which provides at least a processor 204, at least one computer-readable medium 202, and a wireless communication interface 210.

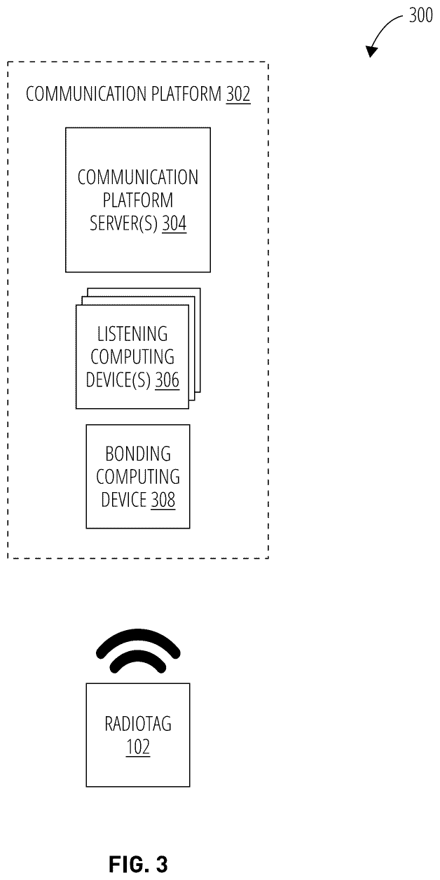

FIG. 3 is a schematic illustration of a basic system in which a radiotag operates, according to various aspects of the present disclosure. In the system 300, the radiotag 102 uses wireless communication to participate in a communication platform 302. The typical communication platform 302 is a platform that allows a user to determine the location of the radiotag 102, and thereby find an item associated with the radiotag 102 (e.g., a key ring, a wallet, an item of luggage, any other object connected to the radiotag 102, the radiotag 102 itself, etc.).

The communication platform 302 includes a bonding computing device 308, one or more listening computing devices 306, and one or more communication platform servers 304. In actual embodiments, the communication platform 302 may include multiple bonding computing devices 308 for use by multiple end users or a single user, but a single bonding computing device 308 is illustrated and discussed herein for the sake of clarity.

At a high level, the system 300 operates by the radiotag 102 broadcasting a plurality of wireless messages, or beacons, that are generated according to a format defined by the communication platform 302. The beacons may be received by one or more of a plurality of listening computing devices 306, which are typically more highly functional computing devices that are capable of determining their own location. As a non-limiting example, a smartphone may be used as a listening computing device 306, and upon receiving a beacon, may transmit the beacon along with the location of the smartphone at the time the beacon was received to the communication platform servers 304.

The beacons can be used by the communication platform server 304 to identify the radiotag 102, but the contents are typically encrypted or otherwise obfuscated using information known to the communication platform servers 304 but not the listening computing devices 306. By doing so, the listening computing devices 306 can report the position to the communication platform servers 304 of where the beacon was received, but the listening computing devices 306 cannot otherwise track the radiotag 102 or determine the identity of a user associated with the radiotag 102. This allows the communication platform 302 to safely and reliably use a large number of listening computing devices 306 within the communication platform 302 to report locations of radiotags 102 without compromising security or privacy of the users of the radiotags 102. For example, the Find My Device platform provided by Alphabet, Inc. is a non-limiting example of a communication platform 302 appropriate for use with embodiments of the present disclosure. In the Find My Devices platform, any computing device running the Android operating system that opts in to the Find My Device network may act as a listening computing device 306, even if owned by someone other than the owner of the radiotag 102. This provides a high likelihood that, even if misplaced, a listening computing device 306 will eventually find itself within range of the beacons broadcast by the radiotag 102 and will be able to report its location to the communication platform servers 304.

The communication platform servers 304 may include one or more server computing devices and/or one or more computing devices of a cloud computing system. The communication platform servers 304 are configured to store information associated with each radiotag 102 that allows the radiotag 102 to be identified, and to store the location information provided by the listening computing devices 306. The communication platform servers 304 are also configured to provide a user interface that presents locations detected for a radiotag 102 to the owner of the radiotag 102.

As initially manufactured, a radiotag 102 does not typically include the encryption keys and/or other information used to communicate with the communication platform 302, at least because this information will be associated with an end user who obtained the radiotag 102 (and who is not known at the time of manufacture). In order to use the radiotag 102 with the communication platform 302, an end user performs a bonding process using a bonding computing device 308. One non-limiting example of a bonding computing device 308 is a smartphone, on which an app may be executed that performs the bonding process. In some embodiments, the bonding process may include an initial handshake between the radiotag 102 and the bonding computing device 308 to establish a communication link between the radiotag 102 and the bonding computing device 308 (e.g., a Bluetooth pairing handshake), and then a handshake between the radiotag 102 and the communication platform servers 304 during which the communication platform servers 304 provide the encryption keys, identifiers, and/or other information to the radiotag 102 that the radiotag 102 will use to generate the beacons.

Previously existing radiotags 102 were typically configured to operate with a single communication platform 302. However, as time has passed, multiple different communication platforms 302 have been developed and have each achieved large user bases. Some non-limiting examples of existing communication platforms 302 include, but are not limited to, the Find My communication platform provided by Apple, Inc.; the Find My Device communication platform provided by Alphabet, Inc., and the Sidewalk communication platform provided by Amazon. com, Inc. Typically, each of these communication platforms provides its own beacon format, stores its own encryption information and identification information, and is otherwise siloed from the other communication platforms. As such, a radiotag 102 configured to operate with one communication platform would not be capable of also operating with a different communication platform. What is desired are techniques that allow a single radiotag 102 to support communication with more than one communication platform.

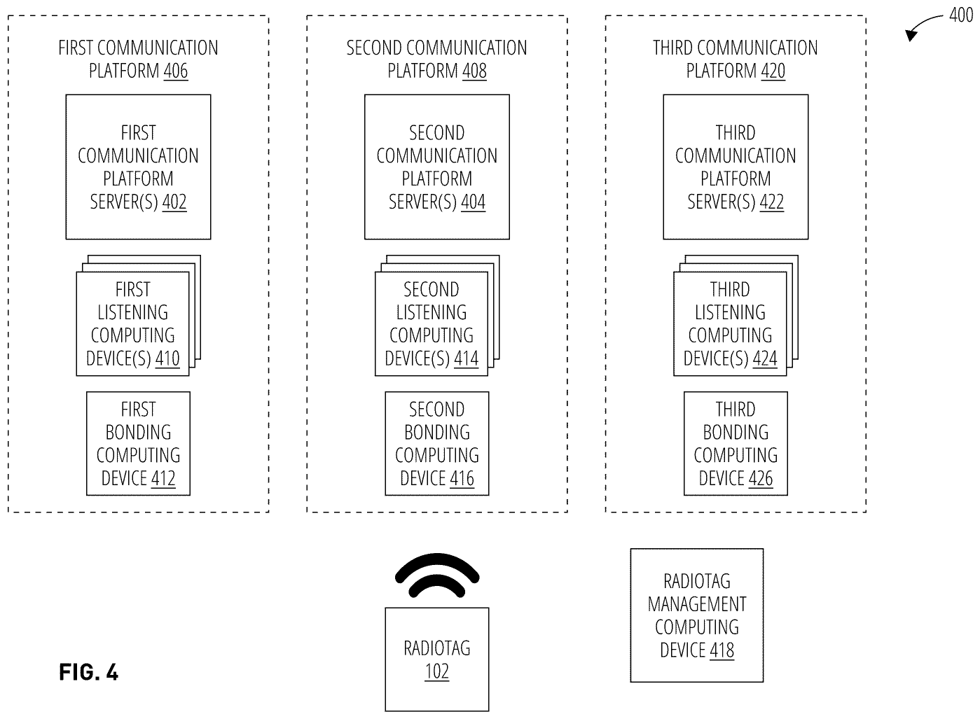

FIG. 4 is a schematic illustration of a system in which a single radiotag supports communication with one of a plurality of communication platforms, according to various aspects of the present disclosure. As shown, the system 400 includes a radiotag 102, a first communication platform 406, a second communication platform 408, a third communication platform 420, and a radiotag management computing device 418. Each of the communication platforms includes the components of a communication platform 302 illustrated in FIG. 3. That is, the first communication platform 406 includes one or more first communication platform servers 402, one or more first listening computing devices 410, and a first bonding computing device 412; the second communication platform 408 includes one or more second communication platform server 404, one or more second listening computing device 414, and a second bonding computing device 416, and the third communication platform 420 includes one or more third communication platform server 422, one or more third listening computing device 424, and a third bonding computing device 426.

Each of the communication platforms 406, 408, 420 may provide a software developer kit (SDK) that includes computer-executable instructions that may be used by a radiotag 102 to communicate with the respective communication platform. The SDK may include logic that implements the handshake between the radiotag 102 and the bonding computing device, the handshake between the radiotag 102 and the communication platform servers, and that transmits the beacons in the appropriate format for the communication platform.

In some embodiments, the system 400 may also include a radiotag management computing device 418. The radiotag 102 may also be configured to communicate with the radiotag management computing device 418 in order to perform various management tasks relating to the radiotag 102 itself, including but not limited to providing over-the-air firmware updates to the radiotag 102. In some embodiments, the radiotag management computing device 418 may be any type of computing device capable of wireless communication with the radiotag 102, including but not limited to a mobile computing device such as a smartphone or a tablet computing device. In some embodiments, the radiotag management computing device 418 may be a bonding computing device from one of the communication platforms, with the radiotag management functionality being provided by a separate app from the communication platform functionality.

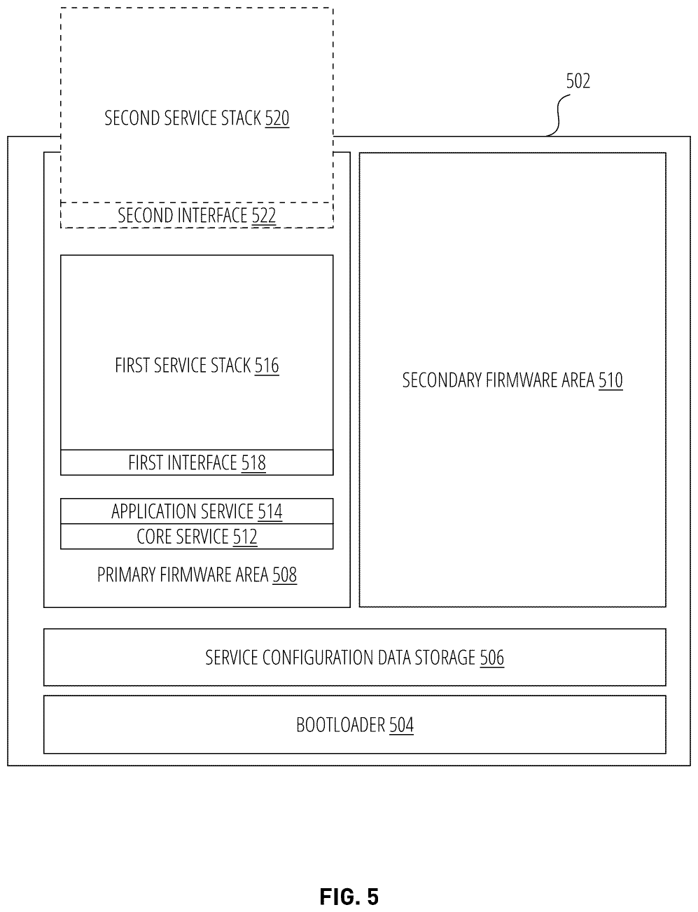

FIG. 5 is a schematic illustration of a computer-readable medium of a radiotag that illustrates example technical problems in implementing a radiotag that is compatible with more than one communication platform. As illustrated, the computer-readable medium 502 is divided into several areas that store different types of computer-executable instructions and/or computer-readable data: areas for a bootloader 504, a service configuration data storage 506, a primary firmware area 508, and a secondary firmware area 510. In some embodiments, the illustrated computer-readable medium 502 may be provided by separate computer-readable media within the radiotag 102. For example, the bootloader 504, the primary firmware area 508, and the secondary firmware area 510 may be provided in one or more flash memory devices, while the service configuration data storage 506 may be provided in a separate flash memory device. In some embodiments, the computer-readable medium 502 may be provided in a single flash memory device.

In some embodiments, the area for the bootloader 504 may store instructions that implement an initial startup the radiotag 102. As a non-limiting example, the bootloader 504 may determine an active firmware (e.g., the primary firmware area 508 or the secondary firmware area 510, and may then launch the core service 512 provided by the active firmware.

In some embodiments, the area for the service configuration data storage 506 may be a general storage area provided as part of the computer-readable medium 502, and may be used for storing the bonding information that associates the radiotag 102 with its corresponding communication platform and that allows generation of encrypted beacons, as specified by the corresponding communication platform.

The remaining space within the computer-readable medium 502 is divided between a primary firmware area 508 and a secondary firmware area 510. Though this cuts an available storage space within the computer-readable medium 502 for the firmware in half, having a primary firmware area 508 and a secondary firmware area 510 allows the firmware to be reliably updated (a new firmware can be copied into the secondary firmware area 510 and verified before switching from the previous firmware, thereby avoiding the possibility of placing the radiotag 102 in an unrecoverable state if errors occur during the installation of the new firmware).

Since the size of the primary firmware area 508 is relatively small, the difficulties in supporting more than one communication platform are readily apparent. As shown, the primary firmware area 508 at least includes instructions that, in response to execution, cause the radiotag 102 to provide a core service 512 and an application service 514. The core service 512 is configured to provide various low-level services, including but not limited to thread scheduling, access to the wireless communication interface 210, interrupt generation, and other core operations that interact with the hardware components of the radiotag 102. The application service 514 is configured to provide higher-level logic that is common to the communication platforms, including but not limited to starting/ending the transmission of advertising messages, starting/ending the transmission of beacons once the radiotag 102 is bonded to a communication platform, detecting and responding to events generated by the hardware of the radiotag 102, and/or other application-level logic. In some embodiments, actions described as being performed by the core service 512 may instead be performed by the application service 514, and vice versa.

Once the instructions for these base components are stored in the primary firmware area 508, the remaining space for communication platform-specific instructions is fairly small. For communication with the first communication platform 406, a first service stack 516 and a first interface 518 are provided. The first service stack 516 provides the specific functionality for interacting with the first communication platform 406 (e.g., handshake protocols, beacon formats, etc.), while the first interface 518 provides a layer of abstraction between the application service 514 and the functionality of the first service stack 516. In some embodiments, both the first service stack 516 and the first interface 518 may be provided by the first communication platform 406 (e.g., provided in an SDK of the first communication platform 406). In some embodiments, the first service stack 516 may be provided by the first communication platform 406 (e.g., in an SDK), and the first interface 518 may be developed by the manufacturer of the radiotag 102 in order to utilize the first service stack 516 with the application service 514.

As seen in FIG. 5, once these components for communicating with the first communication platform 406 are stored in the primary firmware area 508, there is not enough room in the primary firmware area 508 for the instructions needed to communicate with a different communication platform. The second service stack 520 and the second interface 522, which would be used to communicate with the second communication platform 408, are illustrated in dashed line because they do not fit within the remaining free space of the primary firmware area 508. What is desired are techniques that allow instructions for communicating with more than one communication platform to be stored concurrently within the limited firmware storage provided by a radiotag 102.

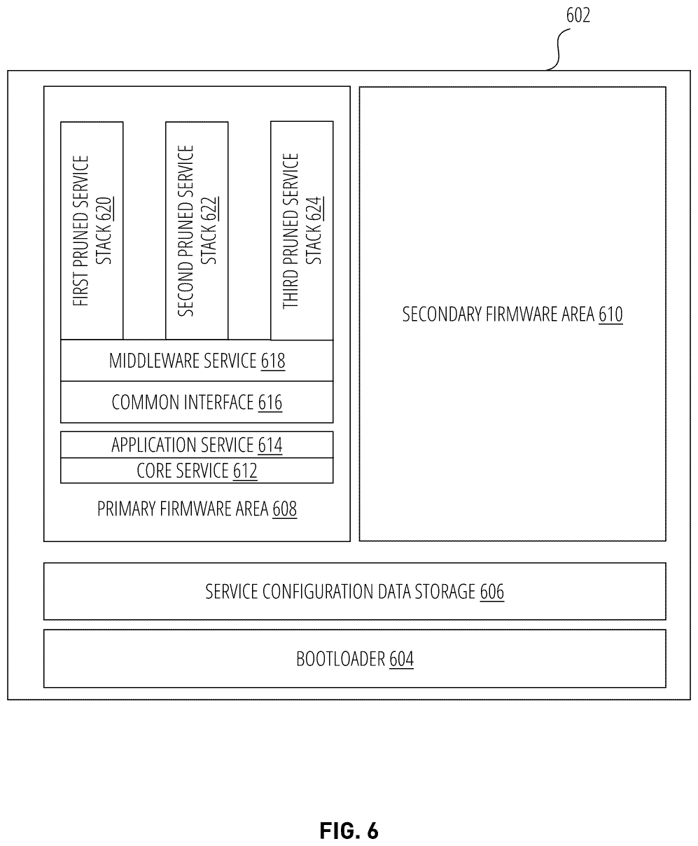

FIG. 6 is a schematic illustration of a computer-readable medium of a radiotag that shows a non-limiting example of techniques for overcoming technical problems in implementing a radiotag that is compatible with more than one communication platform, according to various aspects of the present disclosure. Similar to the computer-readable medium 502 illustrated in FIG. 5, the computer-readable medium 602 of FIG. 6 is also divided into an area for storing a bootloader 604, an area for service configuration data storage 606, a primary firmware area 608, and a secondary firmware area 610. The primary firmware area 608 also stores a core service 612 and an application service 614 that are similar to the core service 512 and application service 514 illustrated in FIG. 5.

The difference in FIG. 6 is that, instead of directly using the first service stack 516 provided by the first communication platform 406 and adding a first interface 518 for use with the first service stack 516, alterations are made in order to reduce the storage space used within the primary firmware area 608 for both the first service stack and one or more other service stacks that will now fit within the primary firmware area 608.

As shown, the size of the first pruned service stack 620 itself is reduced from the size of the first service stack 516 illustrated in FIG. 5. This is accomplished by removing portions of the service stack from the SDK provided by the first communication platform 406 that are not used in operation of the radiotag 102. For example, for the Find My Device communication platform provided by Alphabet, Inc., a service stack that supports FastPair communication is used. However, the entirety of the FastPair functionality may not be used by a radiotag 102.

For example, FastPair supports functionality such as Subsequent Pairing, Message Streams, Battery Notifications, Audio Switches, and/or other functionality not supported by or needed by the radiotag 102. Accordingly, the service stack for the FastPair SDK may be pruned to remove the portions of code that implement these unsupported features. As another example, for the Find My communication platform provided by Apple, Inc., firmware update capability is provided over a proprietary UARP protocol. Since the middleware service 618 (or another service stack) provides firmware update capabilities for the radiotag 102 as a whole as described in further detail below, the firmware update capability of the Find My service stack can be removed.

Reducing the size of the first pruned service stack 620 leaves additional room for storing a second pruned service stack 622 and a third pruned service stack 624, which are also reduced in size compared to unaltered versions provided by the corresponding communication platforms. However, if each of the service stacks were to be accompanied by its own interface (as illustrated by the first interface 518 and second interface 522 in FIG. 5), there would still not be enough room in the primary firmware area 608 for all of the service stacks. Accordingly, instead of providing separate interfaces for the first pruned service stack 620, the second pruned service stack 622, and the third pruned service stack 624, the primary firmware area 608 instead includes a common interface 616 that is used by the application service 614 and/or the core service 612 to communicate using any of the service stacks. The common interface 616 includes methods, callbacks, properties, and/or other application programming interface (API) constructs that are common across all service stacks for implementing the functionality of the radiotag 102, including but not limited to advertising the presence of the radiotag 102 to the corresponding communication platforms, generating beacons directed to corresponding communication platforms, updating battery levels, causing the radiotag 102 to play a jingle or other alert tone, and/or other common actions. The API elements of the common interface 616 are connected to the communication platform-specific API elements of each service stack via middleware service 618. Because the middleware service 618 merely connect API elements of the common interface 616 to the corresponding API elements of each service stack, significant storage space may be conserved compared to storing a full interface (such as first interface 518 and second interface 522) for each service stack.

Though described as implementing communication with communication platforms 302, in some embodiments, a service stack may provide a different type of functionality. As a non-limiting example, a service stack may provide functionality for communication with a radiotag management computing device 418 for various tasks, including but not limited to providing over-the-air updates of the firmware on the computer-readable medium 602.

Once more than one communication platform is supported by the radiotag 102, additional technical problems arise. For example, while the radiotag 102 includes logic for communicating with more than one communication platform, the radiotag 102 can only be bonded to a single communication platform at a time for various reasons, including but not limited to the small amount of space for storing bonding information provided by the service configuration data storage 606, the shortened life of the battery 206 caused by constantly executing more than one bonded service stack, and other reasons. Further, since the radiotag 102 typically includes only minimally functional HCl devices 208 (often only a single button or motion sensor device), the radiotag 102 is unable to choose a communication platform to communicate with via direct user input. What is desired are techniques that would allow the radiotag 102 to determine—without user input at the radiotag 102 itself other than perhaps an input to place the unbonded radiotag 102 in a pairing mode—which of the several communication platforms to interact with. What is also desired are techniques that can efficiently choose a service stack to execute once the radiotag 102 has been bonded to a communication platform, in order to eliminate any need for user input or significant delays upon reboot.

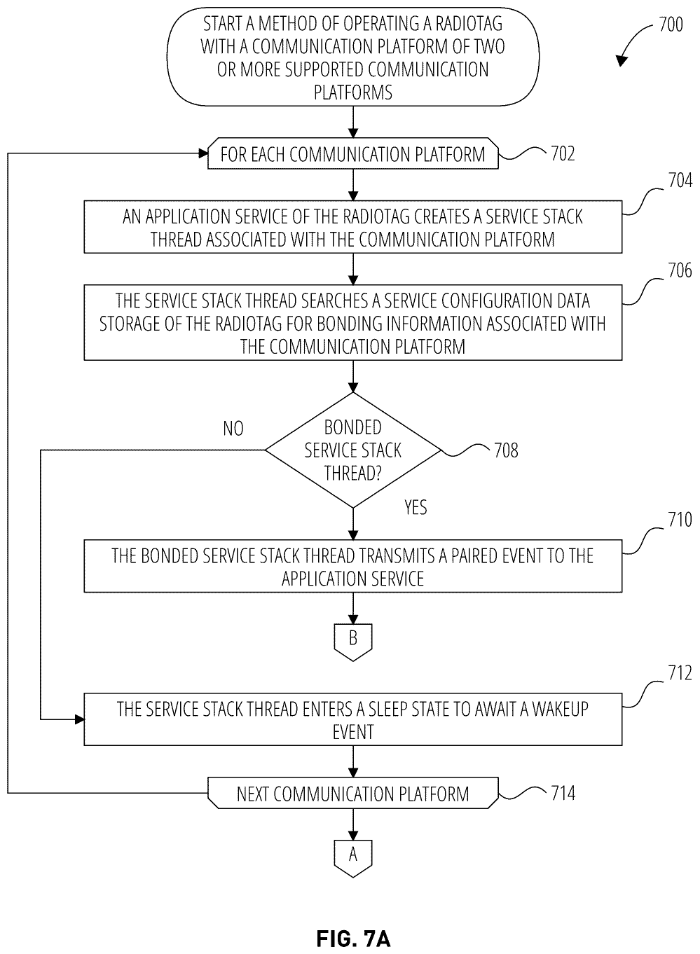

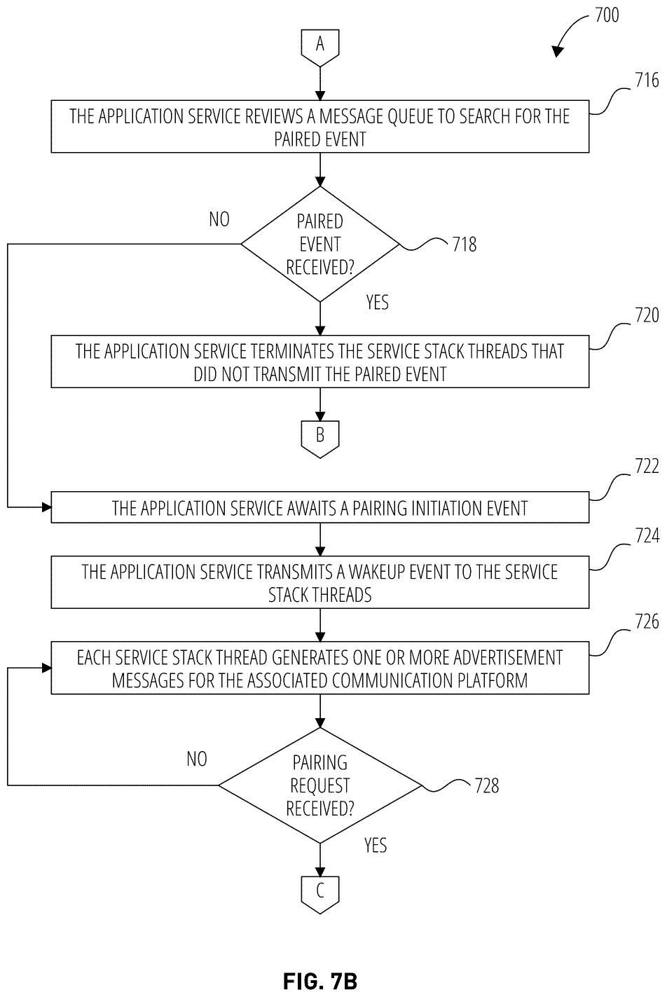

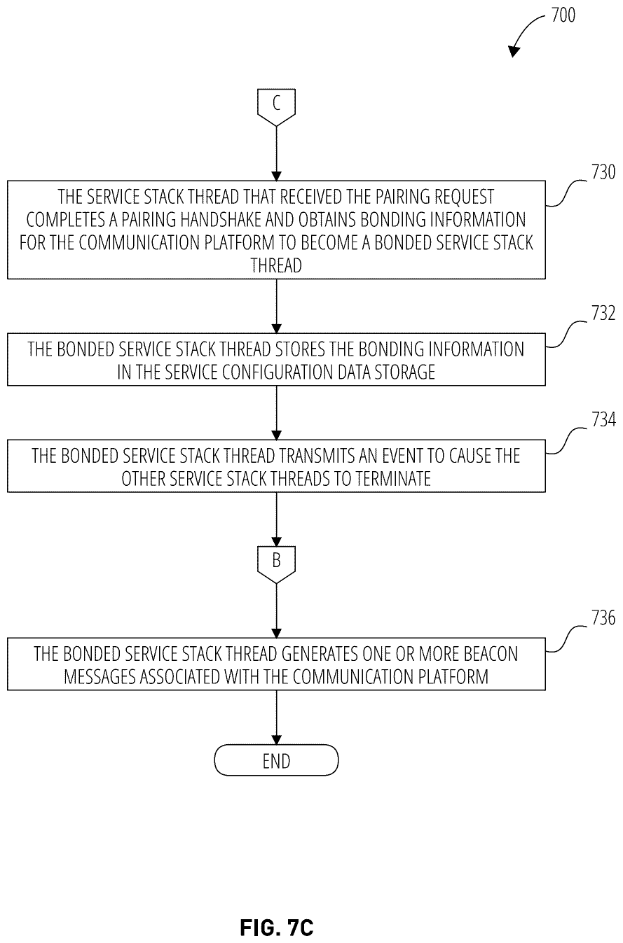

FIG. 7A-FIG. 7C are a flowchart that illustrates a method of operating a radiotag with a communication platform of two or more supported communication platforms according to various aspects of the present disclosure. In the method 700, the radiotag 102 automatically bonds to one of its supported communication platforms without a user input at the radiotag 102 indicating which communication platform should be used. The method 700 also seamlessly reconnects to the bonded communication platform upon reboot and prevents unbonded service stacks from consuming more than a minimal amount of resources.

From a start block, the method 700 advances to a for-loop defined between a for-loop start block 702 and a for-loop end block 714. In some embodiments, the start of the method 700 may correspond to an initial boot of the radiotag 102 after being obtained by an end user. In some embodiments, the start of the method 700 may represent another boot of the radiotag 102, including but not limited to after replacing the battery 206 (if the battery 206 is removable), after charging a depleted battery 206 to a minimum viable state of charge, after receiving a reboot command via an HCl device 208, or after receiving a factory reset command via an HCl device 208. The start of the method 700 may include additional boot-up steps (including but not limited to loading the core service 612 and/or application service 614) that are not illustrated, but would be understood to be present by one of ordinary skill in the art.

In the for-loop, actions are performed for each supported communication platform.

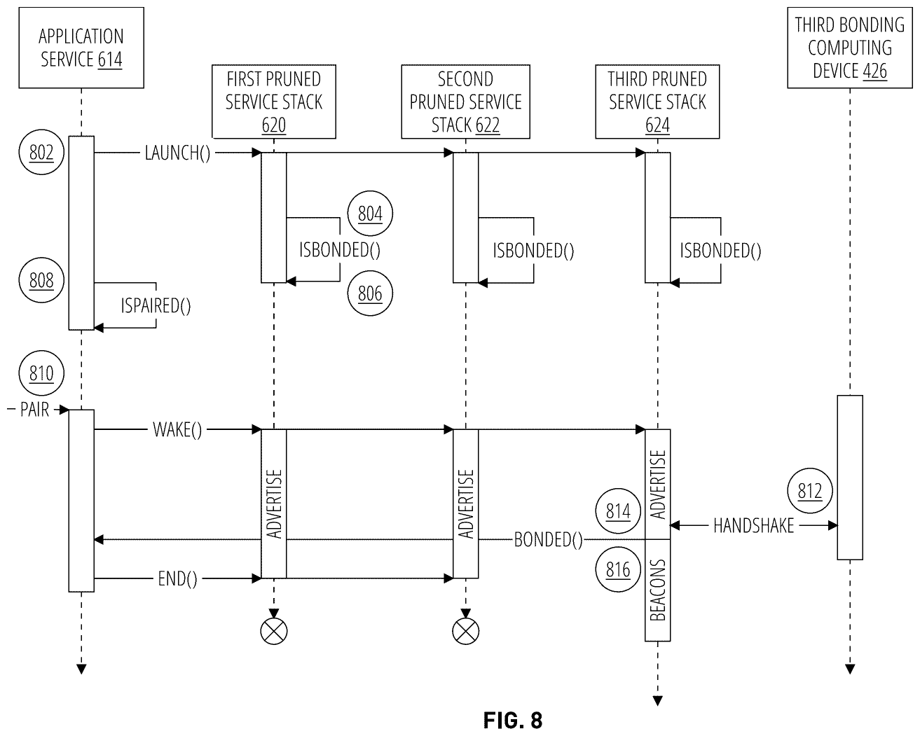

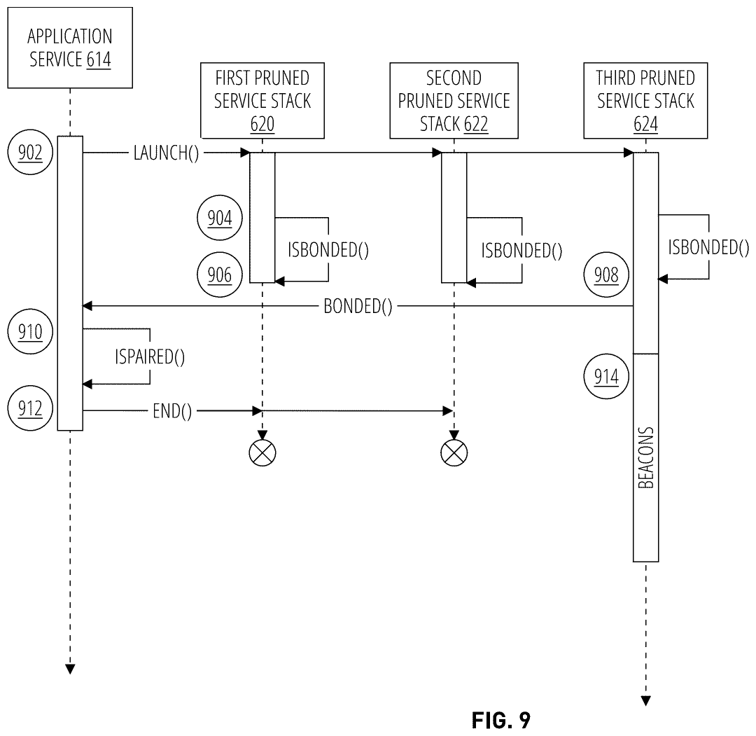

While FIG. 7A illustrates this as a loop in series, this is done for the sake of clarity to indicate that the actions within the for-loop are performed for each of the supported communication platforms. In typical embodiments, at least some of the actions illustrated in the for-loop are performed concurrently for all of the supported communication platforms, whether actually at overlapping times or logically concurrently as managed in interleaved time slices by a thread scheduler. The actions of the for-loop for one communication platform may continue after the for-loop has completed for other communication platforms. Additional illustrations of the timing and concurrency of the actions of the method 700 are provided below with respect to FIG. 8 and FIG. 9.

From the for-loop start block 702, the method 700 proceeds to block 704, where an application service 614 of the radiotag 102 creates a service stack thread associated with the communication platform. The service stack thread is a programming construct for executing the instructions of the corresponding pruned service stack. For example, for the first communication platform 406, a first service stack thread will be created to execute the instructions of the first pruned service stack 620. By executing the instructions of each pruned service stack in a separate service stack thread, a scheduler of the radiotag 102 may interleave the operations related to each of the pruned service stacks, thus causing the radiotag 102 to provide the functionality of the pruned service stacks essentially in parallel.

At block 706, the service stack thread searches a service configuration data storage 606 of the radiotag 102 for bonding information associated with the communication platform. During the process of bonding with a communication platform, the radiotag 102 may receive various bonding information, including but not limited to an identifier of the radiotag 102 within the communication platform; one or more encryption keys, timestamps, or other information used for generating beacons for reception by the communication platform; and/or other information for establishing communication with the communication platform and/or identifying the radiotag 102. In some embodiments, the bonding information may be stored in the service configuration data storage 606 along with an identifier of the communication platform and/or pruned service stack that it is associated with. Accordingly, the search at block 706 may include determining whether the service configuration data storage 606 includes stored bonding information that has the identifier associated with the communication platform/pruned service stack. In some embodiments, the service configuration data storage 606 has room for bonding information for a single communication platform at a time, so a fixed location may be used and searched for the identifier of the communication platform.

At decision block 708, a determination is made regarding whether the service stack thread found the bonding information associated with the communication platform, and is thus a bonded service stack thread. The term “bonded service stack thread” is used herein for clarity in order to disambiguate a service stack thread that has access to its bonding information (and will therefore eventually remain running to generate beacons) from service stack threads that have not, but otherwise does not necessarily indicate any differences between the bonded service stack thread and the other service stack threads.

If the bonding information was found and the service stack thread is therefore a bonded service stack thread, then the result of decision block 708 is YES, and the method 700 proceeds to block 710. At block 710, the bonded service stack thread transmits a paired event to the application service 614. In some embodiments, the paired event is transmitted by creating an entry in a message queue. In some embodiments, the paired event is transmitted using a callback or other inter-thread communication technique. These examples should not be seen as limiting, and any other suitable technique may be used to transmit the paired event to the application service 614. In some embodiments, the paired event at least includes information indicating the identity of the bonded service stack thread. The method 700 then proceeds to a continuation terminal (“terminal B”).

Returning to decision block 708, if the bonding information was not found and the service stack thread is therefore not a bonded service stack thread, then the result of decision block 708 is NO, and the method 700 proceeds to block 712. At block 712, the service stack thread enters a sleep state to await a wakeup event. Any suitable technique may be used to enter the sleep state, including but not limited to calling a wait( ) method. The method 700 then proceeds to the for-loop end block 714.

If further communication platforms remain to be processed, then the method 700 returns to for-loop start block 702 to perform actions for the next communication platform. Otherwise, if all of the communication platforms have been processed and all of the service stack threads are either asleep or executing as a bonded service stack thread, then the method 700 advances from the for-loop end block 714 to a continuation terminal (“terminal A”).

From terminal A (FIG. 7B), the method 700 proceeds to block 716, where the application service 614 reviews a message queue to search for the paired event. Naturally, if the paired event was transmitted using a technique other than a message queue, the application service 614 will use a suitable technique to determine whether it has received the paired event.

The method 700 then proceeds to a decision block 718, where a determination is made based on whether the paired event was found in the message queue. If the paired event was found, then it is an indication that there is a bonded service stack thread. Otherwise, if the paired event was not found (that is, if none of the service stack threads found their bonding information in the service configuration data storage 606), then it is an indication that none of the service stacks have been bonded yet.

If the paired event was found, then the result of decision block 718 is YES, and the method 700 proceeds to block 720, where the application service 614 terminates the service stack threads that did not transmit the paired event. The application service 614 may use the information from the paired event to determine which service stack thread is the bonded service stack thread, and may terminate each of the other service stack threads in order to reclaim their resources. The method 700 then advances to a continuation terminal (“terminal B”).

Returning to decision block 718, if the paired event was not found, then the result of decision block 718 is NO, and the method 700 proceeds to block 722, where the application service 614 awaits a pairing initiation event. In some embodiments, the application service 614 may include a thread or may register a callback with the core service 612 that listens for input received by an HCl device 208. Once an input is received, the application service 614 may analyze the input to determine whether it represents a pairing initiation event. For example, the application service 614 may determine whether the input received by the HCl device 208 indicates a predetermined number of button presses within a predetermined amount of time, such as a double-press of the HCl device 208 within a second (or any other pattern), or may determine whether the input is received by an HCl device 208 that is not easily accessible (e.g., a recessed button instead of a more easily actuated button). By awaiting an input that is unlikely to be inadvertently entered, the application service 614 can avoid initiating the pairing actions if they are not actually desired.

Once the pairing initiation event is received, the method 700 proceeds to block 724, where the application service 614 transmits a wakeup event to the service stack threads. The wakeup event causes each of the service stack threads to exit the sleep state and continue executing its instructions.

At block 726, each service stack thread generates one or more advertisement messages for the associated communication platform. In some embodiments, the advertisement messages generated by each of the service stack threads are different from each other, and may be particularly formatted as expected by its corresponding communication platform. The advertisement messages represent an availability to bond with the corresponding communication platforms. Once generated by the service stack threads, the advertisement messages may be provided by the application service 614 and/or the core service 612 to the wireless communication interface 210, which may transmit the advertisement messages serially once received, may transmit them in round-robin format, or may transmit them in any other non-overlapping manner.

The method 700 then proceeds to a decision block 728, where a determination is made as to whether a pairing request was received from a bonding computing device in response to one of the advertisement messages. Once the radiotag 102 begins transmitting advertisement messages directed to the different communication platforms, in some embodiments, any bonding computing devices within range of the wireless transmissions of the radiotag 102 may present an indication that the radiotag 102 is available for bonding. In other embodiments, a bonding computing device may first be placed into a mode in which it is listening for advertisement messages (e.g., a bonding app or other app associated with the communication platform) before presenting the indication that the radiotag 102 is available for bonding.

It should be noted that, in typical use cases, a single pairing request will be generated by a bonding computing device and received by the radiotag 102 at a time. For example, an end user may have an iPhone and/or other devices within the Apple ecosystem, and so may desired to bond the radiotag 102 to the Find My communication platform provided by Apple, Inc. To do so, the end user will use their iPhone (or other Apple-ecosystem device) as the bonding computing device, and will transmit the pairing request using the iPhone. Even if the end user has devices within range of the radiotag 102 that operate within the other communication platforms (e.g., an Android phone that operates with the Find My Device communication platform or an Alexa device that operates with the Sidewalk communication platform), the end user will typically use just the iPhone to transmit the pairing request. Accordingly, handling the edge case of concurrently receiving pairing requests from multiple bonding computing devices from multiple different communication platforms is not described in detail herein. That said, to handle this edge case, the service stack threads may be designed in any suitable way, including but not limited to allowing the first received pairing request to proceed and blocking others.

If no pairing request has been received, then the result of method 700 is NO, and the method 700 returns to block 726 to generate further advertisement messages. In some embodiments, if pairing requests continue to be missing, the method 700 may loop from decision block 728 back to block 726 a predetermined number of times or for a predetermined elapsed time before the service stack threads return to the sleep state and the method 700 returns to block 722 to await a subsequent pairing initiation event Each service stack thread may return itself to the sleep state after a predetermined amount of time or a predetermined number of iterations, and the service stack threads may use different predetermined amounts of times or numbers of iterations.

Returning to decision block 728, if a pairing request has been received, then the result of decision block 728 is YES, and the method 700 proceeds to a continuation terminal (“terminal C”).

From terminal C (FIG. 7C), the method 700 proceeds to block 730, where the service stack thread that received the pairing request completes a pairing handshake and obtains bonding information for the communication platform to become a bonded service stack thread. Logic for performing the appropriate pairing handshake actions that correspond to the communication platform may be provided within the pruned service stack, and may be provided along with the SDK for the communication platform. In some embodiments, a multiple-step handshake may occur, as described in developer documentation for the communication platform. For example, a first pairing handshake (e.g., a Bluetooth pairing handshake) may establish a communication link between the service stack thread and the bonding computing device of the communication platform. Once the first pairing handshake is performed, a second pairing handshake (e.g., a communication platform handshake) may be used to communicate with the communication platform server and induct the radiotag 102 into the communication platform. During the first pairing handshake, the second pairing handshake, or both, the service stack thread receives the bonding information.

At block 732, the bonded service stack thread stores the bonding information in the service configuration data storage 606. As discussed above, the bonding information may be stored in the service configuration data storage 606 along with an identifier of the pruned service stack or the communication platform to allow the bonding information to be identified at block 706 upon a reboot of the radiotag 102.

At block 734, the bonded service stack thread transmits an event to cause the other service stack threads to terminate. In some embodiments, the bonded service stack thread may transmit the event to the application service 614, which then terminates the other service stack threads in response. By providing the event to the application service 614 and allowing the application service 614 to terminate the other service stack threads, the bonded service stack thread is freed from any requirement of knowing that the other service stack threads are running.

The method 700 then continues through terminal B to block 736, where the bonded service stack thread generates one or more beacon messages associated with the communication platform. The beacon messages are generated according to a format expected by the communication platform, as implemented by the logic of the pruned service stack. In some embodiments, the bonded service stack thread uses the bonding information to generate content for the beacon messages, such as an encryption key, an identifier of the radiotag 102, or other content of the bonding information. The bonded service stack thread may create the beacon messages, and then place them in a queue for transmission by the wireless communication interface 210, provide them to the application service 614 or core service 612 for dispatch to the wireless communication interface 210, or cause the beacon messages to be transmitted using any other suitable technique.

In some embodiments, block 736 is performed until terminated by a user interaction (e.g., a reboot command or a factory reset command input using the HCl device 208) or until inadequate battery power remains to continue running the radiotag 102. The method 700 then proceeds to an end block and terminates.

Though the method 700 is illustrated and described as operating continuously, in some embodiments, the operation of the method 700 may be interrupted in response to a user interaction. For example, in some embodiments, the core service 612, the application service 614, or another software component of the radiotag 102 may receive signals from the HCl devices 208, and may detect a user input that indicates an intent to interrupt the method 700 and place the radiotag 102 in an alternate mode. One non-limiting example of an alternate mode is a radiotag management mode. In such embodiments, upon receiving signals that indicate the user intent (e.g., five actuations of an HCl device 208 such as a button), the application service 614 may cause the bonded service stack thread to pause or terminate, and may cause a radiotag management thread to be launched. The radiotag management thread may use one of the pruned service stacks, or components of the application service 614 or middleware service 618, to attempt to communicate with a radiotag management computing device 418.

If the radiotag management computing device 418 successfully forms a connection to the radiotag 102 during a predetermined time window (e.g., 30 seconds), the radiotag management computing device 418 and radiotag 102 may perform actions associated with the intent indicated by the user input. As one non-limiting example, the radiotag management computing device 418 may play a jingle or other alert (or cause a bonding computing device or another computing device to play a jingle or other alert) to help the user locate the radiotag management computing device 418 or other computing device. As another non-limiting example, the radiotag management computing device 418 may perform an over-the-air update of the firmware of the radiotag 102. If the connection is not successfully formed within the predetermined time window, the application service 614 may terminate the radiotag management thread and cause the radiotag 102 to resume operation either by resuming the bonded service stack thread from a paused state, or by restarting the method 700.

Further, though the method 700 illustrates techniques in which the radiotag 102 may dynamically select a communication platform from multiple supported platforms, it should be noted that these are not the only advantages provided by the improved firmware illustrated in FIG. 6. For example, in some embodiments, the improved firmware illustrated in FIG. 6 may be installed, but at manufacturing time, a flag or other data may be stored in the service configuration data storage 606 that indicates a single pruned service stack that should be executed. While such a radiotag 102 would not be dynamically configurable at run time, the improved firmware nevertheless provides benefits because a single firmware may be developed, tested, and deployed for multiple communication platforms, even if a given radiotag 102 is only configured by the manufacturer to operate with a single communication platform.

This may help to reduce the development, testing, deployment, and version management burden placed on the manufacturer by having to manage different codebases for each of the communication platforms.

FIG. 8 and FIG. 9 are sequence diagrams that illustrate timing aspects of non-limiting examples of the method of operating a radiotag with a communication platform of two or more supported communication platforms as illustrated in FIG. 7A-FIG. 7C, according to various aspects of the present disclosure. FIG. 8 illustrates a non-limiting example of the method 700 wherein none of the service stacks have yet been bonded upon the initial startup of the radiotag 102. FIG. 9 illustrates a non-limiting example of the method 700 wherein the third pruned service stack 624 had previously been bonded to the third communication platform 420 and bonding information for the third communication platform 420 is stored within the service configuration data storage 606 prior to startup of the radiotag 102.

In the sequence diagrams of FIG. 8 and FIG. 9, time extends in a vertical direction, with the passage of time indicated by downward movement in the vertical direction. Actions that are illustrated at the same vertical position in the sequence diagram occur at least partially concurrently, whether actually at overlapping times or logically concurrently as managed in interleaved time slices by a thread scheduler. The boxes at the top of the sequence diagram represent actors (e.g., components of the firmware as illustrated in FIG. 6, or other components of the system 400), and the dotted lines extending therefrom represent the lifetime of threads that execute the respective components. Circles are provided to reference points in the diagram for discussion purposes. In FIG. 8 and FIG. 9, it is assumed that the radiotag 102 is configured to support communication with three different communication platforms, though in other embodiments, a different number of communication platforms may be supported.

Turning first to FIG. 8, upon booting the radiotag 102, the core service 612 starts a thread to execute the application service 614. The application service 614, at point 802, launches a service stack thread for each supported service stack (corresponding to block 704 of FIG. 7A)—a first service stack thread to execute the first pruned service stack 620, a second service stack thread to execute the second pruned service stack 622, and a third service stack thread to execute the third pruned service stack 624.

At point 804, each of the service stacks searches the service configuration data storage 606 to determine whether the bonding information associated with its corresponding communication platform is stored, indicating that the service stack had previously been bonded. In FIG. 8, none of the service stacks had previously been bonded, so at point 806, each of the service stack threads has entered a sleep state (corresponding to block 712 of FIG. 7A).

At point 808, the application service 614 reviews a message queue (or takes another action) to determine whether any of the service stacks had transmitted the paired event to indicate that they had previously been bonded. Since none of the service stacks transmitted the paired event (corresponding to the NO branch of decision block 718 in FIG. 7B), the application service 614 enters a waiting state to await a pairing initiation event (corresponding to block 722 in FIG. 7B).

At point 810, the application service 614 receives the pairing initiation event, and transmits a wakeup event to the service stack threads (corresponding to block 724 of FIG. 7B). Each service stack then generates one or more advertisement messages in a format expected by its corresponding communication platform, which are broadcast by the wireless communication interface 210 (corresponding to block 726 in FIG. 7B).

At point 812, a third bonding computing device 426 of the third communication platform 420 receives an advertisement message generated by the third pruned service stack 624, and responds by initiating a handshake protocol between the third pruned service stack 624 and the third bonding computing device 426. Once the handshake protocol is complete and the third pruned service stack 624 receives bonding information from the third bonding computing device 426 (corresponding to block 730 of FIG. 7C), at point 814, the third pruned service stack 624 transmits an event that causes the other service stack threads to terminate (corresponding to block 734 of FIG. 7C). As specifically illustrated in FIG. 8, the third pruned service stack 624 transmits a bonded event to the application service 614, and the application service 614 in turn terminates the threads for the first pruned service stack 620 and the second pruned service stack 622.

Once the event is transmitted at point 814, then at point 816, the third pruned service stack 624 begins transmitting beacons formatted for the third communication platform 420 (corresponding to block 736 of FIG. 7C). Though not illustrated, the third pruned service stack 624 will continue transmitting beacons as expected by the third communication platform 420, which may periodically be received by one or more third listening computing devices 424 and reported to the third communication platform server 422 to facilitate location of the radiotag 102.

Turning to FIG. 9, upon booting the radiotag 102, the core service 612 starts a thread to execute the application service 614. The application service 614, at point 902, launches a service stack thread for each supported service stack (corresponding to block 704 of FIG. 7A, and similar to point 802 of FIG. 8).

At point 904, each of the service stacks searches the service configuration data storage 606 to determine whether the bonding information associated with its corresponding communication platform is stored, indicating that the service stack had previously been bonded. At point 906, the first pruned service stack 620 and the second pruned service stack 622 had not found their bonding information in the service configuration data storage 606, and so have entered a sleep state (corresponding to block 712 of FIG. 7A). Meanwhile, at point 908, the third pruned service stack 624 had found its bonding information in the service configuration data storage 606, and transmits a paired event to the application service 614 (corresponding to block 710 of FIG. 7A). After transmitting the paired event, at point 914 the third pruned service stack 624 begins transmitting beacons for the third communication platform 420 (corresponding to block 736 of FIG. 7C).

Meanwhile, at point 910, the application service 614 reviews a message queue (or takes another action) to determine whether any of the service stacks had transmitted the paired event to indicate that they had previously been bonded. Unlike FIG. 8 in which none of the service stacks had previously been bonded, in FIG. 9 the application service 614 determines that it had received the paired event from the third pruned service stack 624 (corresponding to the YES branch of decision block 718 in FIG. 7B). Accordingly, at point 912, the application service 614 terminates the first pruned service stack 620 and the second pruned service stack 622 without reawakening them (corresponding to block 720 of FIG. 7B).

One will note an additional technical advantage of the disclosed subject matter that is illustrated by the sequence of events in FIG. 9: once the third pruned service stack 624 is previously bonded, then any subsequent boot of the radiotag 102 while the bonding information for the third pruned service stack 624 remains within the service configuration data storage 606 will result in the service stack threads for the first pruned service stack 620 and second pruned service stack 622 being terminated before broadcasting any advertisements. As such, once the radiotag 102 is bonded to a communication platform, the radiotag 102 seamlessly behaves as if it is designed to operate only with the bonded communication platform. There is no opportunity provided to the end user to bond the radiotag 102 to an additional communication platform without deleting the bonding information for the bonded communication platform from the service configuration data storage 606 due to this automatic termination. Meanwhile, if the bonding information for the bonded communication platform is deleted (e.g., via a factory reset or another interaction that causes the bonding information to be deleted), the radiotag 102 will seamlessly broadcast advertisements for any of the communication platforms, as illustrated in FIG. 8. This seamless switch between multi-platform support and single-platform operation, even given the very limited interactions provided by the HCl devices 208, is an additional technical benefit.

While illustrative embodiments have been illustrated and described, it will be appreciated that various changes can be made therein without departing from the spirit and scope of the invention.

1. A computer-implemented method of operating a radiotag with a communication platform of two or more supported communication platforms, the method comprising:
instantiating, by an application service of the radiotag, a plurality of service stack threads that includes a service stack thread for each of the two or more supported communication platforms;
determining, by each service stack thread, whether bonding information for the communication platform associated with the service stack thread is stored in a service configuration data storage of the radiotag; and
for each service stack thread:
in response to determining that the bonding information for the communication platform associated with the service stack thread is not stored in the service configuration data storage, entering, by the service stack thread, a waiting state; and
in response to determining that the bonding information for the communication platform associated with the service stack thread is stored in the service configuration data storage:
generating, by the service stack thread, one or more beacons in a format for the communication platform associated with the service stack thread.

2. The computer-implemented method of claim 1, further comprising, in response to determining that the bonding information for the communication platform associated with the service stack thread is stored in the service configuration data storage:
transmitting, by the service stack thread, a paired event to the application service of the radiotag to indicate that the service stack thread is a bonded service stack thread.

3. The computer-implemented method of claim 2, further comprising:
in response to determining that the paired event was received, causing, by the application service, the service stack threads other than the bonded service stack thread to terminate.

4. The computer-implemented method of claim 1, further comprising:
in response to determining that the paired event was not received:
waiting, by the application service, until a pairing initiation event is detected;
and
in response to detecting the pairing initiation event, causing, by the application service, each of the service stack threads to:
activate from the waiting state; and
generate one or more advertisement messages in a format for the communication platform associated with the service stack thread.

5. The computer-implemented method of claim 4, further comprising:
transmitting, by a wireless communication interface of the radiotag, the advertisement messages from the service stack threads in a round robin manner.

6. The computer-implemented method of claim 4, further comprising:
in response to a first service stack thread of the plurality of service stack threads receiving a pairing request from a bonding computing device:
performing, by the first service stack thread, a handshake associated with the communication platform of the bonding computing device to become a bonded service stack thread;
transmitting, by the first service stack thread, an event to cause other service stack threads of the plurality of service stack threads to terminate; and
generating, by the service stack thread, one or more beacons in a format for the communication platform associated with the service stack thread.

7. The computer-implemented method of claim 6, wherein performing the handshake with the bonding computing device to become the bonded service stack thread includes:
receiving, by the first service stack thread, bonding information for the communication platform; and
storing, by the first service stack thread, the bonding information in the service configuration data storage.

8. The computer-implemented method of claim 6, wherein performing the handshake with the bonding computing device to become the bonded service stack thread includes:
performing, by the first service stack thread, a Bluetooth pairing handshake to establish a communication link between the first service stack thread and the bonding computing device; and
performing, by the first service stack thread, a communication platform handshake via the communication link to the bonding computing device to induct the radiotag into the communication platform.

9. The computer-implemented method of claim 4, wherein the pairing initiation event is a multiple press of a button of the radiotag.

10. A radiotag, comprising:
a wireless communication interface;
at least one processor; and
a non-transitory computer-readable medium that includes:
a primary firmware area; and
a secondary firmware area;
wherein the primary firmware area has stored therein computer-executable instructions comprising:
two or more pruned service stacks;
a common interface;
a middleware service that connects the common interface to the two or more pruned service stacks; and
an application service;
wherein each pruned service stack of the two or more pruned service stacks includes a subset of instructions of a service stack for communicating with a corresponding communication platform; and
wherein the application service accesses functionality of the two or more pruned service stacks via the common interface and the middleware service.

11. The radiotag of claim 10, wherein the primary firmware area and the secondary firmware area have matching sizes.

12. The radiotag of claim 10, wherein the two or more service stacks include a first pruned service stack for communicating with a first communication platform, a second pruned service stack for communicating with a second communication platform, and a third pruned service stack for communicating with a radiotag management computing device.

13. The radiotag of claim 10, wherein the non-transitory computer-readable medium further includes a service configuration data storage; and
wherein the instructions, in response to execution by the at least one processor, cause the radiotag to perform actions comprising:
instantiating, by the application service, two or more service stack threads, wherein each service stack thread executes the instructions of a pruned service stack of the two or more pruned service stacks, and wherein executing the instructions of the pruned service stack includes:
determining, by the service stack thread, whether bonding information for the communication platform associated with the pruned service stack is stored in the service configuration data storage;
in response to determining that the bonding information for the communication platform associated with the pruned service stack is not stored in the service configuration data storage, entering, by the service stack thread, a waiting state; and
in response to determining that the bonding information for the communication platform associated with the pruned service stack is stored in the service configuration data storage:
generating, by the service stack thread, one or more beacons in a format for the communication platform associated with the pruned service stack.

14. The radiotag of claim 13, wherein executing the instructions of the pruned service stack further includes:
transmitting, by the service stack thread, a paired event to the application service to indicate that the service stack thread is a bonded service stack thread.

15. The radiotag of claim 14, wherein the actions further comprise:
in response to determining that the paired event was received, causing, by the application service, the service stack threads other than the bonded service stack thread to terminate.

16. The radiotag of claim 13, wherein the actions further comprise:
in response to determining, by the application service, that the paired event was not received:
waiting, by the application service, until a pairing initiation event is detected;
in response to detecting the pairing initiation event, causing, by the application service, each of the service stack threads to perform actions comprising:
activating from the waiting state; and
generating one or more advertisement messages in a format for the associated pruned service stack; and
transmitting, by the wireless communication interface, the advertisement messages from the service stack threads.

17. The radiotag of claim 16, wherein transmitting the advertisement messages from the service stack threads includes transmitting the advertisement messages from the service stack threads in a round robin manner.

18. The radiotag of claim 13, wherein executing the instructions of the pruned service stack further includes:
in response to a first service stack thread receiving a pairing request from a bonding computing device:
performing, by the first service stack thread, a handshake associated with the communication platform of the bonding computing device to become a bonded service stack thread, wherein the handshake includes receiving bonding information for the communication platform;
storing, by the first service stack thread, the bonding information in the service configuration data storage;
transmitting, by the first service stack thread, an event to cause other service stack threads to terminate; and
generating, by the service stack thread, one or more beacons in a format for the communication platform associated with the pruned service stack.

19. The radiotag of claim 18, wherein performing the handshake with the bonding computing device to become the bonded service stack thread includes:
performing, by the first service stack thread, a Bluetooth pairing handshake using the wireless communication interface to establish a communication link between the first service stack thread and the bonding computing device; and
performing, by the first service stack thread, a communication platform handshake via the communication link to the bonding computing device to induct the radiotag into the communication platform.

20. A non-transitory computer-readable medium having computer-executable instructions stored thereon that, in response to execution by one or more processors of a radiotag, cause the radiotag to perform actions for operating the radiotag with a communication platform of two or more supported communication platforms, the actions comprising:
instantiating, by an application service of the radiotag, a plurality of service stack threads that includes a service stack thread for each of the two or more supported communication platforms;
determining, by each service stack thread, whether bonding information for the communication platform associated with the service stack thread is stored in a service configuration data storage of the radiotag; and
for each service stack thread:
in response to determining that the bonding information for the communication platform associated with the service stack thread is not stored in the service configuration data storage, entering, by the service stack thread, a waiting state; and
in response to determining that the bonding information for the communication platform associated with the service stack thread is stored in the service configuration data storage:
generating, by the service stack thread, one or more beacons in a format for the communication platform associated with the service stack thread.
